(19) United States
(12) Patent Application Publication
(10) Pub. No.: US 2008/0121190 A1
(43) Pub. Date: May 29, 2008

(54) Portion controlling treat dispenser

(76) Inventor: Reynolds Ellsworth Moulton, Brooklyn, NY (US)

Correspondence Address: Reynolds E. Moulton III, 158 Summit Street, Brooklyn, NY, 11231, US

(21) Appl. No.: 11/450,976

(22) Filed: Jun. 12, 2006

(51) Int. Cl. A01K 29/00

(52) U.S. Cl. 119/710; 119/707; 119/709; 446/475

(57) ABSTRACT

In an embodiment, a portion controlling treat dispenser according to this invention comprises housing. At least one treat holding chamber is disposed within the housing. At least one dispensing opening is configured in the housing and in communication with the treat holding chamber. At least one adjustment device is coupled to the treat holding chamber, wherein the quantity of treat exposed through the dispensing opening is controlled by operating the adjustment device.

### FIELD OF THE INVENTION

This invention relates generally to treat dispensers, and more particularly to, a portion controlling treat dispenser e.g. for pets.

### BACKGROUND OF THE INVENTION

Conventional treat dispensers especially those in the form of toys that store treats have a construction that would result in either the treat e.g. hard treat getting trapped inside or the treat e.g. smooth treat such as, peanut butter staying inside as a residue after use. In this type of construction, the trapped or residual treat could potentially eventually support the growth of potentially harmful microbials (molds, yeasts and bacteria) or become rancid from prolonged exposure to light and oxygen, leading to unpleasant odor or taste.. Further, there is no control by user over the quantity of treat dispensed which can potentially result in excess feeding or under feeding.

Thus, there exists a need for a treat dispenser that would (i) prevent residue or wastage of treat inside the dispenser, and (ii) allow treat to be administered at user's desired level.

### SUMMARY OF THE INVENTION

In an embodiment, the treat dispenser according to this invention comprises a housing, at least one treat holding chamber disposed within the housing, at least one dispensing opening configured in the housing and in communication with the treat holding chamber; and at least one adjustment device coupled to the treat holding chamber, wherein the quantity of treat exposed through the dispensing opening is controlled by operating the adjustment device.

In another embodiment, a treat dispenser comprises a housing and a means for holding and dispensing a treat configured inside the housing wherein the quantity of treat dispensed is controlled.

### BRIEF DESCRIPTION OF THE DRAWINGS

FIG. 1 shows a cross-section of the portion controlled treat dispenser according to one embodiment of this invention.

FIG. 2 shows a perspective view of the portion controlled treat dispenser according to an embodiment of this invention.

### DETAILED DESCRIPTION OF THE DRAWINGS

Various embodiments of this invention provide a treat dispenser for pets such as, for example, dogs, cats, birds, etc. However, the embodiments are not limited and may be implemented in connection with human beings e.g. for food dispensing to children, teething device for babies, etc.

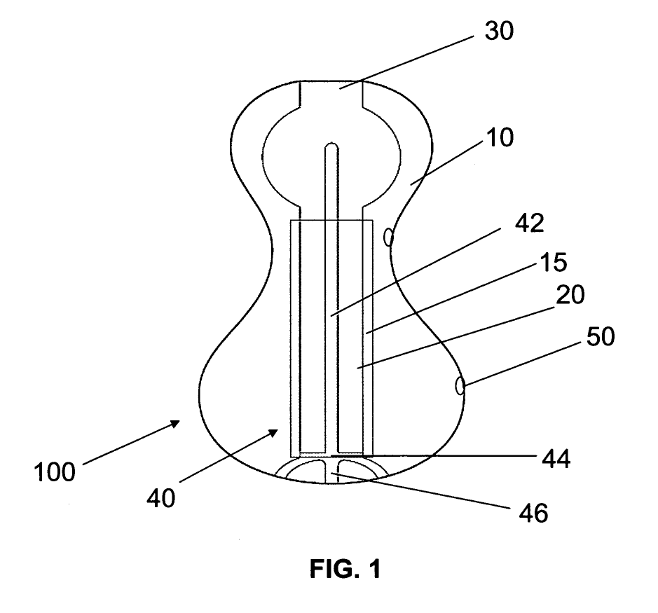

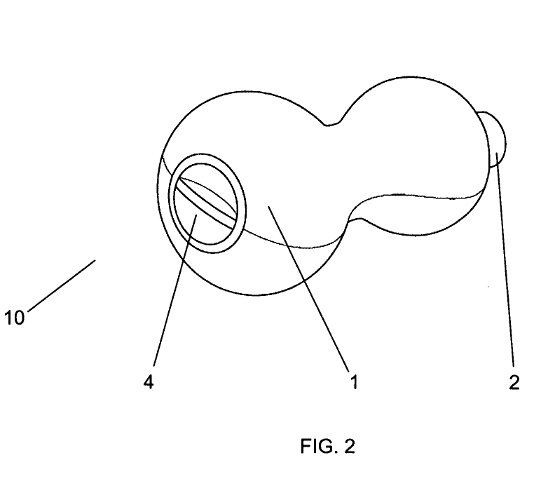

FIG. 1 and FIG. 2 show an embodiment wherein the treat dispenser 100 according to this invention comprises a housing 10. At least one treat holding chamber 15 is disposed within the housing 10. At least one dispensing opening 30 is configured in the housing 10 and in communication with the treat holding chamber 15. At least one adjustment device 40 is coupled to the treat holding chamber 15, wherein the quantity of treat 20 exposed through the dispensing opening 30 is controlled by operating the adjustment device 40.

In an embodiment, the adjustment device 40 comprises a rotary threaded member 42 coupled to a moveable base 44 wherein the base 44 moves upon rotation of the threaded member 42. A knob 46 is coupled to the threaded member 42 wherein the knob 46 is rotated for rotating the threaded member 42. In an example, the treat 20 is configured in the form of a solid shaped object over the base 44. As the knob 46 is rotated by a user, the threaded member 42 rotates and the base 44 moves up or down in response to the direction and amount of rotation of the knob 46. The movement of the base 44 up or down advances or retreats the treat 20 through the dispensing opening 30. Thus, the quantity of treat 20 to be exposed for dispensing is controlled by turning the knob 46 to required degree and in appropriate direction.

In a typical example of the application of this invention, the length of each solid shaped treat is about 4.5 inch, and may be made available in sets of about four to five treats 20 in a pack (not illustrated in the drawings). During use, for example, one treat 20 at a time may be loaded into the treat holding chamber 15 through the dispensing opening 30. In loaded position, the treat 20 is contained within the treat holding camber 15 and is not exposed through the dispensing opening 30. During dispensing operation, for example, the knob 46 is rotated to the extent of how much the exposure and feeding of the treat 20 is required as desired by the user. For example, for feeding larger sized dogs, the length of treat exposed through the dispensing opening 30 can be set large by turning the knob 46 to a larger extent. For a smaller sized dog, the rotation of the knob 46 can be kept as little as to how much the treat 20 needs to be exposed. This demonstrates that the amount of treat 20 required to be exposed for dispensing is controlled using the adjustment device 40 depending on the feeding requirement. It should be noted that this configuration does not allow any residue or wastage of treat inside the dispenser 100. The likelihood of generation of bad smell and environmental problems are also avoided.

In an embodiment, the treat holding chamber 15 is constructed from a rigid rubber or a metallic material. In one example the rubber material of the treat holding chamber is ABS rubber.

In an embodiment, the housing 10 is constructed from a chewable material such as, for example, vulcanized rubber.

In further embodiments, the housing 10 is configured in the form of a toy for attracting the pet. It should be noted that this configuration enables the treat dispenser 100 to be used as a chew toy.

In some embodiments, the housing may have attractive colors and figures to attract the pet.

In some embodiments, a plurality of teasing holes 50 may be provided in the periphery of the container 10. It should be noted that the teasing holes 50 are configured such that the treat 20 does not pass through but allow dispensing of scent of the treat 20 to attract the pet.

In some embodiments, the size of the housing 10 may be configured large or small depending on the usage requirement, and the size of the treat holding chamber 15 may be kept constant for the purposes of design standardization. For example, for use with larger sized pets, the housing 10 may have a larger size, and for use with smaller sized pets, the housing 10 may have a smaller size. However, the size of the treat holding chamber 15 may remain constant and configured for fitting on to both smaller and larger sized housing 10.

Although the above embodiments illustrate the use of this invention with pets, it should be noted that the application is not limited. For example, the treat may be a human food and may be used as a play toy, as feeding device for children, teething baby, etc.

It should be noted that some embodiments are possible wherein the housing 10 may be absent.

Thus, various specific embodiments of this invention provide a treat dispenser 100. Further embodiments of this invention provide a chew toy. It will be obvious for a person skilled in the art to practice the invention with modifications. However, all those modifications are deemed to be covered within the scope of the claims covered herein.

What is claimed is:

1. A portion controlling treat dispenser, comprising:
(i) a housing;
(ii) at least one treat holding chamber disposed within the housing;
(iii) at least one dispensing opening configured in the housing and in communication with the treat holding chamber; and
(iv) at least one adjustment device coupled to the treat holding chamber, wherein the quantity of treat exposed through the dispensing opening is controlled by operating the adjustment device.

2. A treat dispenser according to claim 1 wherein the adjustment device comprises a rotary threaded member coupled to a moveable base wherein the base moves upon rotation of the threaded member.

3. A treat dispenser according to claim 1 further comprising a knob coupled to the threaded member wherein the knob is configured operable by a user for rotating the threaded member.

4. A treat dispenser according to claim 1 wherein the treat is configured in the form of a solid shaped object supported on the moveable base.

5. A treat dispenser according to claim 1 further comprising the treat holding chamber constructed from a rigid rubber or a metallic material.

6. A treat dispenser according to claim 5 wherein the rubber is ABS.

7. A treat dispenser according to claim 1 wherein the housing is constructed from a chewable material.

8. A treat dispenser according to claim 7 wherein the material is vulcanized rubber.

9. A treat dispenser according to claim 1 further configured for use as a chew toy.

10. A treat dispenser according to claim 9 further comprising a plurality of teasing holes at the periphery of the housing wherein the scent of the treat is dispensed through the teasing holes.

11. A treat dispenser according to claim 1 wherein the treat comprises a human food or a pet food.

12. A treat dispenser, comprising:
(i) a housing; and
(ii) a means for holding and dispensing a treat configured inside the housing wherein the quantity of treat dispensed is controlled.

13. A treat dispenser according to claim 12 further comprising the housing configured in the form of a chew toy.

14. A treat dispenser according to claim 13 wherein the means for holding and dispensing the treat comprises a rotary threaded member coupled to a base wherein the quantity of treat dispensed is controlled by varying the rotation of the threaded member.

15. A treat dispenser according to claim 14 further comprising a knob coupled to the threaded member wherein the knob is rotated for rotating the threaded member.

16. A treat dispenser according to claim 13 wherein the material of the housing is vulcanized rubber.

17. A treat dispenser according to claim 12 further comprising a plurality of teasing holes at the periphery of the housing.

18. A treat dispenser according to claim 12 wherein the treat is a pet food or a human food.

19. A treat dispenser according to claim 18 wherein pet includes at least one among bird, cat and dog.

20. A treat dispenser according to claim 18 wherein human includes at least children or a teething baby.
